(19) United States
(12) Patent Application Publication
(10) Pub. No.: US 2011/0117470 A1
(43) Pub. Date: May 19, 2011

(54) FUEL CELL SYSTEM

(75) Inventors: Özer Aras, Berlin (DE); Christian Leu, Berlin (DE); Andreas HIerl, Berlin (DE); Patrice Herold, Berlin (DE)

(73) Assignee: HELIOCENTRIS ENERGIESYSTEME GMBH, Berlin (DE)

(21) Appl. No.: 12/736,524

(22) PCT Filed: Apr. 20, 2009
(86) PCT No.: PCT/EP2009/054683

§ 371 Date: Dec. 28, 2010

(30) Foreign Application Priority Data
Apr. 18, 2008 (DE) 10 2008 020 762.4

(51) Int. Cl. H01M 8/24

(52) U.S. Cl. 429/452

(57) ABSTRACT

The invention relates to a fuel cell system comprising a housing including a chamber for accommodating a fuel cell stack. The fuel cell system has various features that can also be independently embodied, namely: a U-shaped air channel including air inlet channels and air outlet channels which include an inlet or outlet on the same side of the housing of the fuel cell system; at least two fans or compressors that are disposed downstream of each other in an air flow direction in the air inlet channel or in the air outlet channel; a housing that has two additional, separate housing sections apart from a chamber for a fuel cell stack and an air inlet channel and an air outlet channel; and an air bypass channel which is arranged between an air inlet channel for introducing ambient air into a chamber for the fuel cell stack and an air outlet channel for discharging air from the chamber for the fuel cell stack.

### CROSS REFERENCE TO RELATED APPLICATIONS

This application is the U.S. National Stage of International Application Number PCT/EP2009/054683 filed on Apr. 20, 2009, which was published on Oct. 22, 2009 under International Publication Number WO 2009/127743.

### BACKGROUND OF THE INVENTION

1. Technical Field

The invention relates to a fuel cell system for a fuel cell stack. The invention relates less to the fuel cell stack itself, but rather to additional components of the fuel cell system for media supply and for setting operating parameters for a fuel cell stack, like in particular a housing and a media supply with water and hydrogen and its control.

2. Discussion of Related Art

Typical components of a fuel cell system are a fuel cell stack which includes the actual fuel cell configured form a plurality of particular cells respectively configured with a cathode and anode and an electrolyte disposed there between, e.g. configured as a membrane, and a housing. The housing includes the necessary components, e.g. air channels and hydrogen conduit which are necessary to supply the required hydrogen to the anodes of the fuel cell stack and to supply the necessary oxygen to the cathodes of the fuel cell stack, e.g. as a portion of the supplied ambient air. Furthermore the fuel cell system includes devices for controlling the respectively provided volume flow of hydrogen and air and for temperature and humidity management, since released reactive heat and water generated have to be removed. For a fuel cell it is important to maintain an advantageous operating temperature if possible during operations.

In this context the invention particularly relates to a fuel cell system with a fuel cell stack with an open cathode in which the anodes to be supplied with hydrogen are connected with channels for a central hydrogen supply, while the cathodes to be supplied with oxygen are quasi freely accessible and disposed adjacent to one another in layers, so that an oxygen supply has to come from the housing of the fuel cell system. The water generated on the cathode side from a reaction of oxygen and hydrogen has to be removed as moisture. Fuel cell stack with an open cathode are known in principle.

### DISCLOSURE OF INVENTION

It is the object of the invention to provide a fuel cell system for a fuel cell stack with an open cathode which facilitates simple and efficient operations.

According to the invention the object is achieved through a fuel cell system which has various features that can also be implemented independently from one another, namely:
a U-shaped air duct including air inlet channels and air outlet channels which include an inlet opening or an outlet opening on the same side of the housing of the fuel cell system, so that air is conducted from this side of the housing through an air inlet channel to a chamber for the fuel cell stack and from there through an air outlet channel back again to the same side of the housing;
at least two fans or compressors that are disposed downstream from one another in airflow direction in the air inlet- or air outlet channel, preferably configured as axial fans or diagonal fans;
a housing that has two additional, separate housing sections apart from a chamber for a fuel cell stack and an air inlet channel and an air outlet channel; namely a housing section for receiving a preferably electronic control and a second housing section for receiving all components which are being used for introducing hydrogen into the fuel cell stack and discharging hydrogen from the fuel cell stack; and
a bypass air channel which is arranged between an air inlet channel for introducing ambient air into a chamber for a fuel cell stack and an air outlet channel for discharging air from the chamber for the fuel cell stack.

All these features by themselves or in combination with one another provide optimized air ducting. How this is done can be derived from the subsequent descriptions of preferred embodiments.

Additional aspects of the invention which can also be implemented independently from one another relate to:
a chamber for receiving a fuel cell stack, the chamber configured so that the fuel cell stack is disposed slanted relative to the housing and the chamber; and
a closed, in particular thermally insulated housing.

### BRIEF DESCRIPTION OF THE DRAWINGS

The particular aspects of the invention which can also be implemented independently from one another and particularly preferred variants of the particular aspects and particularly preferred combination of the aspects are subsequently described in more based on embodiments with reference to drawing figures, wherein:

FIG. 1: illustrates a schematic lateral view through a preferred fuel cell system;

FIG. 2 illustrates a view similar to FIG. 1 for illustrating additional housing sections of the fuel cell system of FIG. 1;

FIGS. 3a-3c illustrates a fuel cell system similar to FIG. 1with an additional bypass air channel;

FIGS. 4a & 4b illustrate a modular fuel cell system in a detailed view;

FIG. 5 illustrates a schematic view, wherein plural lifters are being used in an air inlet channel or in an air outlet channel for an air supply to a fuel cell stack;

FIG. 6 illustrates a fuel cell stack with an open cathode and air scoops connected thereto;

FIG. 7 illustrates an advantageous embodiment of the fuel cell stacks and the air scoops;

FIG. 8 illustrates a particular preferred variant for a chamber for a fuel cell stack;

FIG. 9 illustrates a schematic view of a relative arrangement of an air inlet channel and a air out let channel for a fuel cell stack;

FIG. 10 illustrates a schematic view of a preferred relative arrangement of a chamber for a fuel cell stack and additional components for controlling the fuel cell system and for components for hydrogen supply.

### DETAILED DESCRIPTION

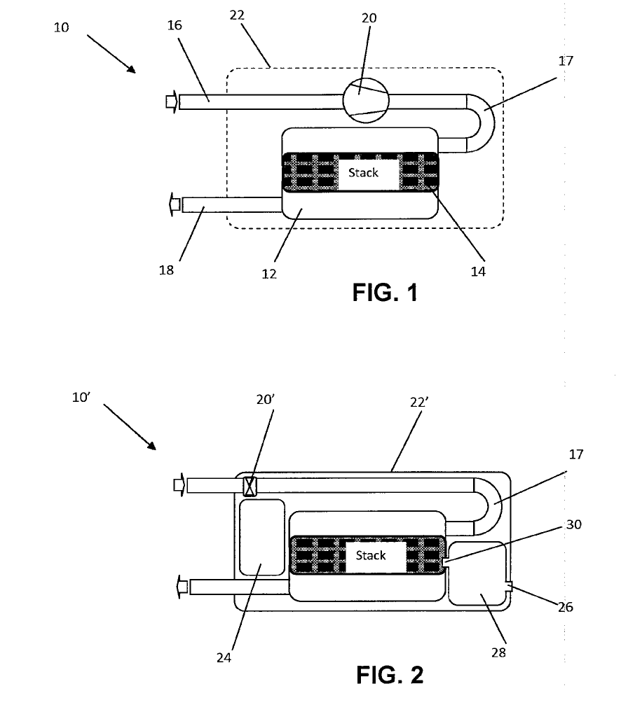

FIG. 1 illustrates a schematic horizontal sectional view of a fuel cell system 10 with a chamber 12 for a fuel cell stack 14 and an air inlet channel 16 to a chamber 12 and an air outlet channel 18 from the chamber 12. Between the air inlet channel 16 and the chamber 12 a deflection channel 17 is disposed through which the air flowing though the air inlet channel 16 is deflected in a U-shape by 180°. Furthermore a compressor or fan 20 is schematically illustrated in the air inlet channel 16. These components are enclosed by a schematically illustrated housing 22.

According to an independent feature of the invention the air inlet channel 16, the deflection channel 17, the air outlet channel 18, the chamber 12 and the fan 20 are configured as independent modules which are exchangeable and combinable with one another any manner.

Thus FIG. 1 illustrates an first feature of the invention according to which the air inlet channel 16 and the air outlet channel 18 originate respectively on the same side of the housing 22 (the left side in the figure). This provides an advantageous U-shaped air duct which facilitates disposing the fuel cell system in a space in any arrangement, wherein optionally the air inlet channel and the air outlet channel can lead into the ambient or into the space. Accordingly the fuel cell system can be disposed in the space.

FIG. 2 illustrates a fuel cell system 10′ similar to the one illustrated in FIG. 1, wherein on the one hand the fan 20 configured as an axial fan 20′ is illustrated. Furthermore FIG. 2 illustrates that the housing 22′ includes a proper housing section 24 for receiving control components, this means particularly configured for receiving control electronics, and a third additional housing section 26 for receiving the components for the hydrogen supply. As can already be derived from FIG. 2, the third housing section 26 for receiving the components for hydrogen supply preferably includes a hydrogen connection 28, which is not disposed on the same housing side, like the openings of the air inlet channel 16 and the air outlet channel 18, but which is disposed on another, preferably opposite housing side. On the side of the chamber 12 for the fuel cell stack 14, a connection terminal 30 is provided through which the fuel cell stack 14 has to be connected with the components for the hydrogen supply (not illustrated in FIG. 2) in the third housing component 26, so that the required hydrogen can be supplied to the fuel cell stack 14 through the connection terminal 30. Providing proper housing sections for control components and for components for hydrogen supply represents a second feature of the invention which can also be implemented independently.

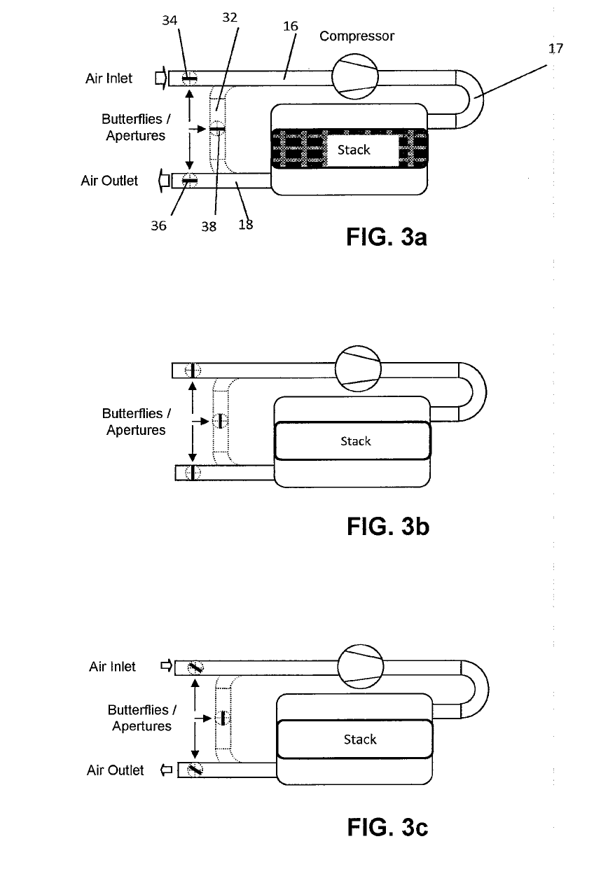

FIGS. 3a-3c eventually illustrate a third feature of the invention which can also be implemented independently, wherein the feature includes a bypass air channel 32, which connects the air inlet channel 16 with the air outlet channel 18. As can also be derived from the three figures, an air supply flap 34 is provided in the air inlet channel 16, an air outlet flap 36 is provided in the air outlet channel 18, and a recirculation flap 38 is provided in the air bypass channel 32. An air inlet flap, air outlet flap and recirculation air flap in the sense of the invention designates any device through which a hydraulic diameter of the air inlet channel, air outlet channel or bypass channel can be changed in a controlled manner, thus e.g. also an iris aperture or a slide.

Also the bypass channel 32 and the air inlet flap 34 and the air outlet flap 36 can be configured as exchangeable modules that can be combined in any manner, so that a modular configuration of the fuel cell system is provided overall.

FIG. 3a illustrates an operating condition in which the air inlet flap 34 and the air outlet flap 36 are completely open and the recirculation air flap 38 is completely closed, so that the bypass air channel 32 is de facto ineffective and the fuel cell system operates like a conventional fuel cell system.

For cold ambient temperatures, e.g. ambient temperatures of less than 10° C., the air inlet flap 34 and the air outlet flap 36 can be closed for starting the fuel system 10 and the recirculation air flap 38 can be opened, so that de facto no ambient air is sucked into the air inlet channel 16, but so that air rather circulates through the air inlet channel 16, the chamber 12 for the fuel cell stack 14 the air outlet channel 18 and the air bypass channel 32. This way, the heat generated in the fuel cell stack 14 can be used effectively and the fuel system 10 can be brought to an advantageous operating temperature of e.g. 50° C. to 60° C. in an advantageous manner as quickly as possible. This is illustrated in FIG. 3b.

As illustrated in FIG. 3c, a partial recirculation of the air run through the chamber 12 can also be provided by opening or closing the air inlet flap 34 and the air outlet flap 36 or closing it, while the recirculation flap 28 is open.

A fuel cell system 10 with a bypass air channel 32 provides the following possible operating modes.

For example, the air can be recirculated in the system several times, e.g. 10-fold until the fuel cell stack 14 has reached an acceptable temperature of at least e.g. 20° C. Thus, as illustrated in FIG. 3b, the air inlet flap 34 and the air outlet flap 36 are closed and the recirculation flap 38 is open. When a fuel cell stack temperature of approximately 20° C. is reached, the air inlet flap 34 and the air outlet flap 36 in turn can be opened completely or partially in order to partially or completely provide ambient air to the fuel cell stack.

Instead of closing the air inlet flap 34 and the air outlet flap 36 completely, when starting the fuel cell system as illustrated in FIG. 3b, the air inlet flap 34 and the air outlet flap 36 can also be partially closed and opened as illustrated in FIG. 3c.

With respect to FIGS. 3a-3c, it is appreciated that in case of a bypass air channel 32, a required fan has to be disposed behind the port of the bypass air channel into the air inlet channel 16 and/or in front of the port of the bypass air channel 32 into the air outlet channel 18, so that the fan can also be effective in the operating mode illustrated in FIG. 3b.

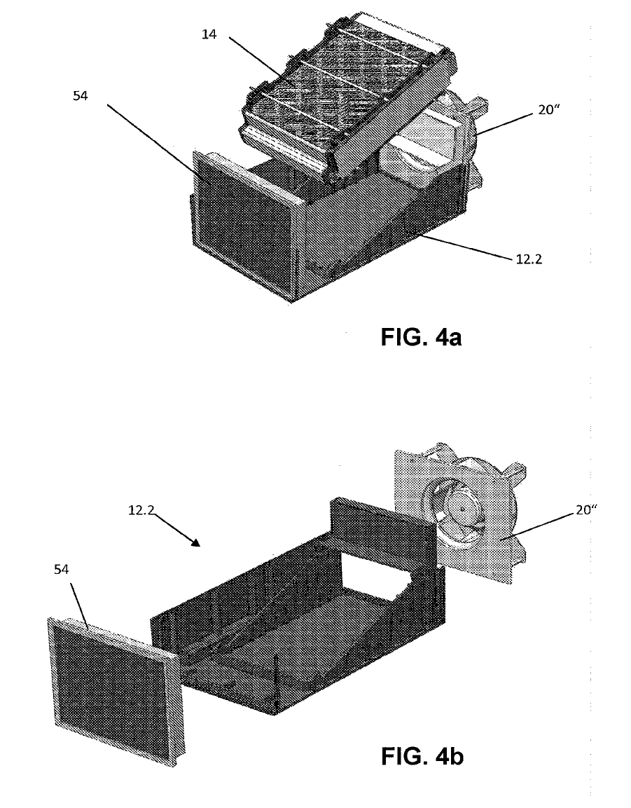

FIGS. 4a and 4b illustrate a modular fuel cell system in a detailed illustration.

According to the preferred embodiment of the chamber 12 illustrated in FIGS. 4a and 4b, the chamber 12 is formed by two shells 12.1 and 12.2. This facilitates assembly. When the upper shell is removed (shell 12.1) all components are easily accessible. The lower shell 12.2 illustrates an opening and a circumferential frame 42 with a seal surface 44. This frame forms a support 42 for the fuel cell stack 14, which closes the opening as soon as the frame is applied. The shell 12.1 includes press contours 52, which press upon the fuel cell stack 14 and press it onto the seal surface 44 of the lower shell 12.2 as soon as the chamber 12 is closed.

Ideally, the contact surface 42 and also the press contours 52 adapt precisely to the geometry of the fuel cell stack. Thus, fixating the fuel cell stack in the chamber is performed through form locking as soon as the chamber is closed and no separate elements are required for attaching the fuel cell stack.

By slanting the fuel cell stack, the chamber 12 is divided, so that two intermediary spaces are created, which are sealed relative to one another through inserting the fuel cell stack. The support 42 for the fuel cell stack simultaneously forms the seal surface. The chamber 12 does not have to be sealed completely any more in outward direction. Air flowing into the first intermediary cavity can only reach the intermediary cavity by flowing through the fuel cell stack 14. A short circuit flow past the fuel cell stack is thus not possible.

Slanting the fuel cell stack provides a very low installation height for the assembly and simultaneously provides optimum air distribution. The fuel cell stack acts like a “divider wall” and forms a tapering first intermediary space 50.1 on the side of the air entry and an expanding second intermediary space 50.2 on the side of the air exit. This assembly provides optimum flow through for the fuel stack itself, and there is no air blockage in the intermediary cavities.

The chamber concept is easily adaptable to different stack sizes of the same type. Only one dimension has to be changed, which can be implemented through accordingly configured intermediary components at the chamber walls.

The chamber concept implements a portion of the preferred modularity in that an air filter 54 or the fan 20″ is easily exchangeable.

A fourth feature of the invention, which can also be implemented independently relates to the compressor 20 schematically illustrated in FIG. 1. According to the feature, plural compressors, e.g. provided in the form of axial compressors, are disposed behind one another in the air cycle (cascaded instead of the typical one compressor). For example, two compressors 20.1 and 20.2 can be disposed behind one another in an air supply channel or two compressors 20.3 and 20.4 can be disposed behind one another in the air outlet channel. By the same token, a first compressor 20.1 can be disposed in the air inlet channel and a second compressor 20.4 can be disposed in the air outlet channel. FIG. 4 illustrates an embodiment with a total of four compressors 20.1-20.4, of which two are respectively disposed in the inlet channel 16 and in the outlet channel 18. Between the inlet channel 16 and the outlet channel 18, a fuel cell stack 14′ is schematically illustrated.

When the compressors are respectively configured as particular modules, they can be combined with one another in any manner and can be adapted in an optimum manner to different operating conditions or fuel cell stacks.

The compressors 20.2-20.4 are preferably axial fans and furthermore preferably have different nominal or maximum power.

By using plural compressors or fans instead of the typical singular compressor or fan, the subsequent problems typically occurring when using only one fan can be avoided:
the minim startup volume flow of the compressor is too high;
the maximum volume flow of the compressor for high ambient temperatures, e.g. more than 35° C. is not sufficient; and
additional pressure losses by including additional conduits after installing the fuel cell system onsite influence the compressor power negatively, and cannot be easily compensated by a single compressor.

When using two compressors, the problem of minimum startup volume flow can be solved in that for minimum air requirement in a partial load range of the fuel flow system only one of the two fans is being operated. When using axial fans, overall a higher pressure difference between inlet and outlet can be generated because the two axial fans are connected in series, so that pressure delivery of the combined compressor arrangement is increased. Alternatively, two compressors can also be disposed in parallel with one another in order to increase volume flow. Thus, the required fan power can be implemented in a more efficient manner through a respective arrangement of the compressors or through controlled switching them on and off, than this would be possible with a single fan, which may have to be operated in partial load operation with a reduced efficiency. This way, also the total efficiency of the fuel cell system can be increased. Overall, thus any power points can be easily controlled through single controlling of the compressors.

In this respect, another feature of the invention can be helpful, which is not depicted in the figures, and which is comprised in that the fan or compressor is associated with an air flap that is spring loaded in operating condition and which acts as a pressure reducer and for optimizing the operating point of the fan in partial load operation, wherein the air flap can be opened under full load, so that it does not operate as a pressure reducer then.

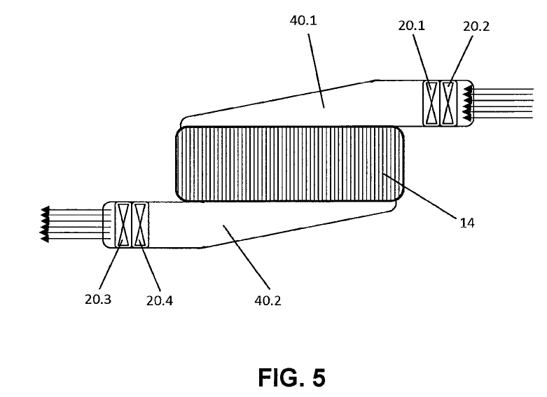

When at least one compressor is disposed in a push mode in the air inlet channel 16 and the other compressor is disposed in the air outlet channel 18 in a suction mode as illustrated in FIG. 5, so that one compressor is disposed on the pressure side and the other compressor is disposed on the suction side, this furthermore provides an improvement of the uniform distribution of the flow over the fuel cell stack 14. Overall, it is advantageous that the volume flow and the pressure of the supply are easily scalable. Furthermore, a simple configuration with low installation size is provided, since also axial fans can be used, which are otherwise rather unfavorable. Eventually, also the even distribution of the airflow over the stack can be improved.

A fifth embodiment of the invention which can also be implemented independently from the other embodiments relates to optimizing the arrangement of the fuel cell stacks 14 in the chamber 12 or the housing 22.

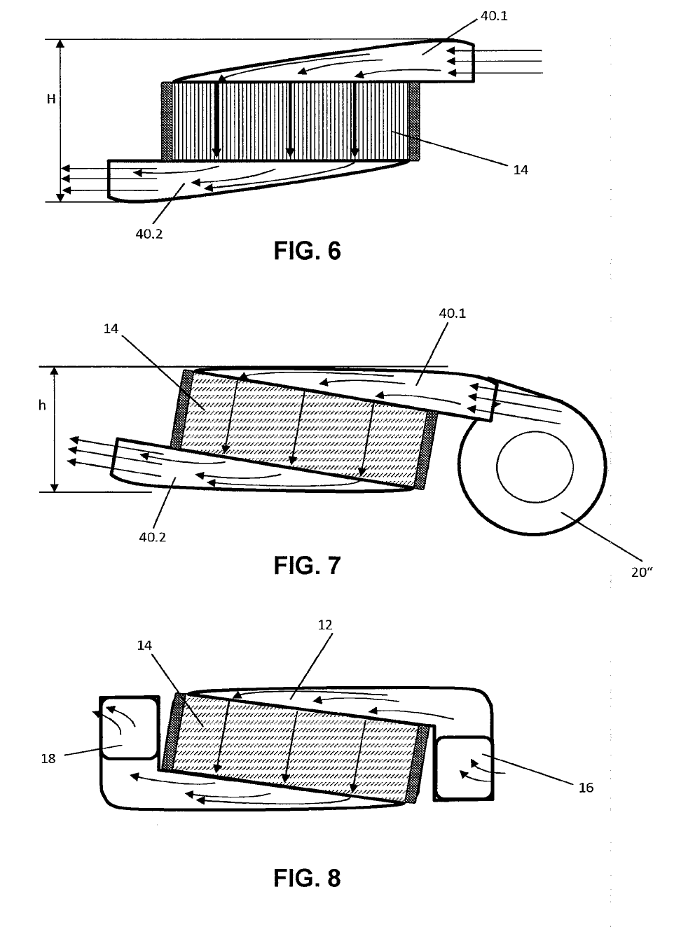

For the fuel cell systems known in the art with a fuel cell stack with an open cathode, typically air scoops 40.1 and 40.2 are provided as they are illustrated in combination with a stack 14 in FIG. 6. Air is supplied to a first air scoop 40.1 and inducted through the air scoop 40.1 into the stack 14 and flows past the open cathodes through the stack to the second air scoop 40.2.

In order to arrive at optimum housing dimensions, which facilitate overall a small exterior housing and thus also overall small heat losses through the housing wall, the fifth embodiment provides disposing the stack 14 at a slant angle as illustrated in FIG. 7. The outsides of the air scoops 40.1 and 40.2 thus extend preferably parallel to an outer wall, e.g. a topside or bottom side of a housing 20 of a fuel cell system 10.

FIG. 7 additionally illustrates a radial fan 20″ configured as a compressor, which is connected to the air inlet scoop 40.1.

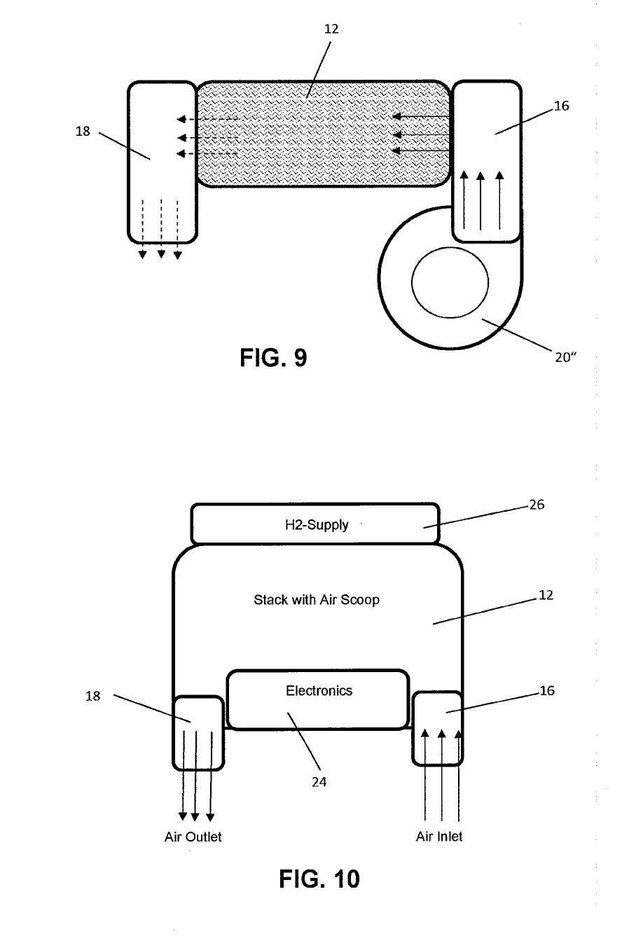

FIG. 8 eventually illustrates a particularly optimized variant of an assembly of a fuel cell stack 14 in a particular chamber 12 of the housing 22. Thus, the chamber 12 is aligned, so that its chamber walls 12.1 and 12.2 extend approximately parallel to outer walls of the housing 22. The fuel cell stack 14 is disposed in the chamber 12 at a slant angle. As can be derived from FIG. 7, furthermore an air inlet channel 16 and an air outlet channel 18 are connected to the chamber 12, so that this yields in top view (FIG. 7 represents a vertical sectional view) an assembly of a chamber 12 for a fuel cell stack 14 and an air outlet channel 18 as schematically illustrated in FIG. 9. Furthermore, the U-shaped air duct according to the invention is illustrated which has already been described with reference to FIGS. 1 and 2. FIG. 9 in turn illustrates a radial fan 20″ configured as a compressor 20 in a schematic manner. Advantageously, an assembly of plural fans can be provided instead of a single radial fan 20″ as described in more detail with reference to FIG. 5.

FIG. 10 eventually illustrates an embodiment again which includes dividing the housing 22 into at least three housing sections, wherein one housing section includes the chamber 12 and the air channels 16 and 18 and a housing section 24 that is separate there from includes control components, and a third housing section 26 eventually includes the components for the hydrogen supply.

When all embodiments which can also be implemented independently from one another are simultaneously implemented in a fuel cell system is provided which has a compact housing with small dimensions. This is preferably made from a heat insulating material for further reducing the heat losses.

The particular embodiments by themselves and in particular in combination with one another implement a fuel cell system which has a high efficiency also in partial load ranges and which can be brought to an optimum operating temperature quickly, also for low ambient temperatures.

1. A fuel cell system comprising a housing including a chamber for receiving a fuel cell stack and including an air inlet channel for introducing ambient air into the chamber and including an air outlet channel for exhausting air from the chamber into ambient, wherein the fuel cell system includes at least two fans or compressors disposed in the air inlet channel and/or air outlet channel behind one another in a flow direction of air.

2. The fuel cell system according to claim 1, wherein the fans are axial fans or diagonal fans.

3. The fuel cell system according to claim 1, wherein the fans have different rated powers and maximum powers.

4. The fuel cell system according to claim 1, wherein at least one fan or compressor is disposed in the air inlet channel and at least one additional fan or compressor is disposed in the air outlet channel.

5. The fuel cell system according to claim 1, wherein an inlet opening of the air inlet channel and an outlet opening of the air outlet channel are disposed on an identical side of the housing of the fuel cell system, which yields U-shaped air ducting.

6. The fuel cell system according to claim 5, wherein the fuel cell system includes a bypass air channel which leads from the air outlet channel to the air inlet channel.

7. The fuel cell system according to claim 6, wherein a device for controlled changing the hydraulic diameter of the bypass air channel for optionally opening or closing the bypass air channel is disposed in the bypass air channel.

8. The fuel cell system according to claim 7, wherein a device for controlled changing the hydraulic diameter of the air inlet or air outlet channel for selectively opening or closing the air inlet channel and/or the air outlet channel is disposed in the air inlet channel and/or the air outlet channel.

9. The fuel cell system, in particular according to claim 1, comprising a housing including a chamber for receiving a fuel cell stack and including an air inlet channel for providing ambient air to the chamber and an air outlet channel for exhausting air from the chamber into ambient and including at least one fan or compressor disposed in the air inlet channel or the air outlet channel, wherein an air flap acting as a pressure reducer is associated with the fan or compressor for optimizing an operating point of the compressor or fan in a partial load range, wherein the flap is operatively spring loaded and openable under full load, so that it does not act as a pressure reducer then.

10. The fuel cell system according to claim 9, wherein the chamber for receiving the fuel cell stack is configured, so that the fuel cell stack is disposed at a slant angle relative to the chamber.

11. The fuel cell system according to claim 10, wherein the fuel cell stack is disposed at a slant angle relative to the outer walls of the housing.

12. The fuel cell system according to claim 9, wherein the housing is configured thermally insulating.
